(19) United States
(12) Patent Application Publication
(10) Pub. No.: US 2022/0000046 A1
(43) Pub. Date: Jan. 6, 2022

(54) PLANT PROTECTION MAT AND METHOD TO PROTECT PLANTS AGAINST SALT DAMAGE

(71) Applicant: Zynnovation LLC, Ashland, VA (US)

(72) Inventors: Wei Zhang, Midlothian, VA (US); Hailing Yang, Midlothian, VA (US)

(73) Assignee: Zynnovation LLC, Ashland, VA (US)

(21) Appl. No.: 17/174,239

(22) Filed: Feb. 11, 2021

Related U.S. Application Data
(60) Provisional application No. 62/975,049, filed on Feb. 11, 2020.

(51) Int. Cl. A01G 13/02

(52) U.S. Cl. CPC A01G 13/0275

(57) ABSTRACT

A method is provided for protecting a plant from the effects of contact or exposure to salt and/or salt water, comprising placing, around or near the plant: a salt protection mat, comprising: a top layer; a center layer disposed beneath the top layer and comprising superabsorbent polymer particles; and a semipermeable bottom layer disposed beneath the center layer; wherein the top layer reduces or prevents evaporative water loss from the center layer; and wherein the semipermeable bottom layer permits water to seep out from the center layer.

### RELATED APPLICATIONS

This application claims the benefit of U.S. Application No. 62/975,049, filed Feb. 11, 2020, the entire contents of which are hereby incorporated by reference.

### BACKGROUND

Sodium chloride, or snow melt/rock salt, is a necessity in modern societies where there are wintry weathers. Applying salt to roads, walkways and parking lots improves safety, but the salt is a menace to plant life. Urban forestry and plants are usually planted in the space on the roadside, road medians and parking lots in urban environments. Because of the plants' proximity to adjacent surfaces such as sidewalks, streets, and the like, the salt, which is applied to melt snow and ice, ends up in the plants' rootzones, leaves, and branches from splashing, surface runoff, wind blowing, vehicle throwing or shoveling. Except for some salt-water species of plant, most plants suffer from the presence of salt. Some are damaged or killed by salt.

In addition to sodium chloride, other salts are also used for deicing and snow removal. Calcium chloride, potassium chloride, calcium magnesium acetate, magnesium chloride, urea, or a combination of these salts are the typical inorganic alternatives to sodium chloride. Beet juice and other agricultural products are also used in areas where they are available. Unfortunately, most of the alternative and agricultural products are cost prohibitive. Further, some of the alternative products to sodium chloride are not harmless—either to the environment or to the plants. As a result, sodium chloride remains as the primary deicing salt.

Plant root cells contain solutes that help to absorb water from the surrounding soil through their semi-permeable cell membrane, to help the plants stay hydrated. But when the solute concentration outside the cell membrane is higher than the solute concentration inside the cell membrane, water flows out of the plant cells. Depending on species, some plants can tolerate this situation to a certain degree and survive. But when the plant's water loss gets beyond a certain point, permanent damage to the plant can and will result. The higher the salt concentration to which the plant is exposed, the faster this process occurs, and the rate of plant damage is increased.

It is all too common to observe the damage and casualties on the roadside in spring, when plants begin to display the impacts of salt through discoloration and canopy loss. At this stage, it is often too late to remedy and save the damaged plants. The urban forestry community is aware of the issue. Many of these professionals have snow removal, for example, through salt application, as part of their responsibilities.

Salt is particularly destructive to plants in green stormwater infrastructures, where plants are used to remove pollutants from stormwater runoff before being discharged into surface waters or to replenish ground water. Green stormwater infrastructures are typically used for treating the first flush of stormwater runoff from surfaces where salts are used. This initial surface runoff of a rain or snow storm contains more pollutants and salt than during the remainder of the storm. The higher salt concentration in this first flush after salt application causes more severe damage to plants.

Other than deicing salts used purposely for snow removal, there are other sources and ways for salts to affect plants: runoff from salt stockyards, areas around oil and gas wells, dredge and runoff from disposal sites, irrigation with saline water or ground water with high salt content, use of reclaimed water, sea water intrusion, and coastal flooding.

Because of the high solubility of sodium chloride in water, conventional methods of removing salts typically require leaching the salt out and then draining the salt water away. These methods undesirably require large amounts of water. Oftentimes, constant irrigation for a certain time is required to completely recover a salt-infused field. At the same time, irrigation systems are not available under wintry weather conditions, which are winterized (turned off and residual water removed with air) prior to freezing conditions. By the spring time when the irrigation systems are turned salt damage already occurred and it is often too late to save the plants by washing off salts. Further, sodium ions can be hard to leach out in soils with very fine particles, such as clay soil. The close texture of clay soil, the large surface area, and the ionic interaction of sodium ions with the surface charged sites on the nanometer-scale clay particles require time for the sodium to leach and drain away. To accelerate the process of leaching sodium salt out of soil, calcium ions in salts like gypsum (calcium sulfate) or lime (calcium carbonate) are sometimes used to replace sodium from the binding sites on the soil particle surfaces.

To date, however, a satisfying solution to the aforementioned problems remains elusive.

### BRIEF DESCRIPTION OF THE SEVERAL EMBODIMENTS

The aforementioned problems, and others, are solved by the present invention, an embodiment of which provides a method for protecting a plant from the effects of contact or exposure to salt and/or salt water, comprising placing, around or near the plant:

a salt protection mat, comprising:

a top layer;

a center layer disposed beneath the top layer and comprising superabsorbent polymer particles; and

a semipermeable bottom layer disposed beneath the center layer;

wherein the top layer reduces or prevents evaporative water loss from the center layer; and wherein the semipermeable bottom layer permits water to seep out from the center layer.

In another embodiment, a method is provided for protecting a plant from the effects of contact or exposure to salt and/or salt water, which comprises placing a plurality of superabsorbent polymer particles around or near the plant, or admixing a plurality of superabsorbent polymer particles with soil or mulch around or near the plant, or a combination thereof.

Without wishing to be bound by theory, the water-absorbing and releasing capacity of super absorbent polymers (SAP) is believed to be dependent on the salt concentration of the water. When a pre-soaked (with a water source having a low concentration of solutes, e.g. rain water or distilled water) SAP material is placed in a water solution with high concentration of solutes, some of the pre-soaked water is released to the surrounding solution. When salty runoff water comes in contact with a pre-soaked SAP material, some of the water in the SAP material is released, which helps to wash away the salt and/or dilute the salt concentration of the surrounding solution, i.e., the salty runoff water. The inventors have now found that surprisingly and unexpectedly, this action of washing away and/or diluting salt concentration by use of a salt protection mat of the present invention can substantially mitigate salt damage to plants.

### DETAILED DESCRIPTION OF THE SEVERAL EMBODIMENTS

The salt against which the invention can protect a plant or mitigate against damage is not particularly limited. For example, the salt can be de-icing salt, salt brine, rock salt, road salt, airborne salt, salt water, salt solution, seawater, reclaimed water, or a combination thereof. The salt water can arise from above the ground surface, below the ground surface, saltwater intrusion, flooding, tide, or a combination thereof. Some typical examples of salt include sodium chloride, calcium chloride, potassium chloride, calcium magnesium acetate, magnesium chloride, urea, or a combination thereof.

The plant which may be protected from salt by the present invention is not particularly limited. Non-limiting examples of plants include trees, shrubs, bushes, urban plants, decorative plants, vegetables, fruit trees, flowers, and the like.

Protecting a plant from the effects of contact with or exposure to salt and/or salt water includes protecting healthy living plants or any part thereof such as plant tissue, roots, branches, fruits, stems, flowers, or leaves from dying, wilting, dropping leaves, abnormal defoliation, or dehydration, or any combination thereof. In addition, protecting a plant includes mitigating or reducing the effects of contact with or exposure to salt and/or salt water, or even contributing to nursing a contacted or exposed plant back to health. Given the teachings herein, one of ordinary skill in urban forestry and/or horticulture could readily determine the effects on a plant from contact with or exposure to salt and/or saltwater and what it means to protect from such effects without undue experimentation.

In one embodiment, the mat is placed on the ground above or near the plant's roots, around or near the base of the plant, of a plant that is or has been exposed or is at risk of exposure to salt or salt water.

In one embodiment, the plant is near or adjacent to a surface (or structure) that is treated with salt during the colder months of the year. Examples of such surfaces include sidewalks, steps, alleys, corridors, streets, roads, runways, curbs, gutters, landings, docks, patios, and the like.

In another embodiment, the plant is near or adjacent to an area that is in regular contact with salt, such as salt storage yards or storage containers, stockyards, salt ponds, oil drilling operations, coastal regions, and the like.

In one embodiment, the mat comprises:

a top layer (sometimes referred to herein as a top cover plate), having a first perimeter edge;

a water-permeable or semi-permeable bottom layer, having a second perimeter edge affixed either directly to the first perimeter edge, or indirectly to the first perimeter edge via an intervening sidewall; and

a water-absorbing and releasing center layer disposed between the top and bottom layers, and comprising superabsorbent particles;

wherein the top layer reduces or prevents evaporative water loss from the center layer; and wherein the bottom layer permits water to seep out from the center layer.

The shape of the salt protection mat is not particularly limited, and the mat can have any shape suitable for placing on the ground near or around a plant and particularly above the plant roots. For example, the mat can be square, rectangular, polygonal, circular, semi-circular, oval, or have another shape when viewed from above. The mat can have, if desired, a hole, access slit, or other cutout to accommodate the base of a tree or plant.

In one embodiment, the superabsorbent polymer particles are free to move within the section of the center layer having superabsorbent particles, or are not free to move within the section having superabsorbent particles. For example, the superabsorbent particles may be fixed or embedded in a matrix in the center layer, such as a non-woven fibrous matrix. Alternatively, the superabsorbent particles may be free particles that can move and shift around in the center layer section having the particles.

In one embodiment, the salt protection mat comprises a hole through the top, bottom, and center layers to accommodate the base (e.g., the trunk or main stem) of a tree or plant, the hole being defined by an interior perimeter edge at which the top and bottom layers are affixed directly to one another, or affixed indirectly to one another via an intervening interior perimeter sidewall.

In one embodiment, the salt protection mat comprises an access slit extending from the hole to the first and second perimeter edges, the access slit being defined by access slit perimeter edges at which the top and bottom layers are affixed directly to one another, or affixed indirectly to one another via intervening access slit perimeter edges sidewalls. The access slit is intended to allow the mat to be placed around the base of a tree or plant, the access slit leading to the hole that accommodates the tree or plant.

In one embodiment, the salt protection mat comprises one or more connections between the access slit perimeter edges, to connect the opposing sides of the access slit together after the mat has been placed around a tree or plant.

In one embodiment, the access slit connections are selected from the group consisting of ties, grommets, Velcro, Velcro tabs, zipper, buttons, snaps, hooks, string, cord, or any combination of two or more thereof.

In one embodiment, the salt protection mat does not comprise a hole through the top, bottom, and center layers.

In one embodiment, the salt protection mat comprises a hole, or more than one hole, but does not have an access slit. This is to allow the mat to be laid down over small plants, or to allow planting in the holes after the mat has been laid down.

In one embodiment, the salt protection mat top layer reduces or prevents evaporative water loss from the center layer.

In one embodiment, the salt protection mat top layer is permeable to one or more of water, atmospheric water, dew, rainwater, applied water, snowmelt, icemelt, or a combination of two or more thereof.

In one embodiment, the mat top layer further comprises one or more perforations, funnel, hole, opening, channel, seam, or a combination of two or more thereof, to permit one or more of atmospheric water, dew, rainwater, applied water, snowmelt, icemelt, or a combination of two or more thereof to penetrate into the center layer.

In one embodiment, the mat can be recharged with fresh water, e.g., during the colder months, in order to extend the effect of protection against salt.

In one embodiment, the salt protection mat the top layer is flexible.

In one embodiment, the salt protection mat top layer is flexible and is made of fabric, woven material, non-woven material, film, plastic, laminate, sheeting, polymer, or a combination of two or more thereof.

In one embodiment, the salt protection mat top layer is polypropylene, polyethylene, polyvinylchloride, polyester, polyurethane, polylactic acid, acrylic, rubber, rayon, cellulose, cotton, burlap, canvas, hemp, paper, biodegradable, biomaterial, bio-based plastic, processed bio-based material, reclaimed plastic, recycled plastic, recycled diaper, recycled rubber, wood, bamboo, agricultural residue, natural weed control fabric, mulch film, WeedGuardPlus® mulch film, biodegradable paper weed barrier, biodegradable natural weed barrier fabric, biodegradable mulch weed barrier, weed barrier film, weed barrier fabric, polylactic acid fabric, plant-based fiber, seed hairs, cotton, stem fiber, bast fiber, flax, straw, hemp, leaf fiber, sisal, husk fiber, coconut fiber, corn fiber, animal-based fiber, wool, hair, secretion fiber, silk, aspen wood fiber, linen, wool, cashmere, jute, abaca, coir, flax, ramie, sisal, mohair, camel hair, angora wool, alpaca wool, straw, or a combination of two or more thereof.

In one embodiment, the salt protection mat top layer further comprises one or more containers with raised rim that can be in form of a funnel, tray, pan, dish, channel, slot, or a combination of two or more thereof, to collect one or more of atmospheric water, dew, rainwater, applied water, or a combination of two or more thereof before it penetrates into the center layer through the perforations at the bottom of the containers, the water being collected and guided into the center layer by the containers.

In one embodiment, the salt protection mat bottom layer further comprises one or more perforations, hole, opening, channel, seam, or a combination of two or more thereof, to permit the release of water from the center layer.

In one embodiment, the salt protection mat bottom layer is flexible.

In one embodiment, the salt protection mat bottom layer is flexible and is made of fabric, woven material, non-woven material, film, plastic, laminate, sheeting, polymer, or a combination of two or more thereof.

In one embodiment, the salt protection mat bottom layer is polypropylene, polyethylene, polyvinylchloride, polyester, polyurethane, polylactic acid, acrylic, rubber, rayon, cellulose, cotton, burlap, canvas, hemp, paper, biodegradable, biomaterial, bio-based plastic, processed bio-based material, reclaimed plastic, recycled plastic, recycled diaper, recycled rubber, wood, bamboo, agricultural residue, natural weed control fabric, mulch film, WeedGuardPlus® mulch film, biodegradable paper weed barrier, biodegradable natural weed barrier fabric, biodegradable mulch weed barrier, weed barrier film, weed barrier fabric, polylactic acid fabric, plant-based fiber, seed hairs, cotton, stem fiber, bast fiber, flax, straw, hemp, leaf fiber, sisal, husk fiber, coconut fiber, corn fiber, animal-based fiber, wool, hair, secretion fiber, silk, aspen wood fiber, linen, wool, cashmere, jute, abaca, coir, flax, ramie, sisal, mohair, camel hair, angora wool, alpaca wool, straw, or a combination of two or more thereof.

In one embodiment, the salt protection mat further comprises a sidewall, which connects the perimeters of the top and bottom layers.

In one embodiment, the salt protection mat is assembled by sewing the top and bottom layers together around their edges, leaving a center layer between them. Sections of the center layer with and without SAP are separated by sewing the top and bottom layers together along the lines dividing the center layer sections with and without SAP.

In one embodiment, the salt protection mat center layer is a hollow portion between the top and bottom layers, the top and bottom layers connected to each other around the edges of the top and bottom layers. SAP is contained in some center layer sections, and other center layer sections do not have SAP.

The arrangement of sections with and without SAP in the center layer is not particularly limited, and those sections can be arranged according to preference. For example, the sections (with and without SAP) can be in the same plane of the center layer and alternate or be in the same plane of the center layer and run lengthwise. Alternatively, the sections with and without SAP can be arranged on top of one another or under one another.

The section of the center layer that does not have SAP can be empty, that is, it does not contain either SAP, water-absorbing material, wicking material, or active material, or it can contain an active material, such as fertilizer, insect repellent, animal repellent, fungicides, pesticides, herbicides, and insecticides, nutrients, and the like.

In one embodiment, SAP is the only water-absorbing and releasing material in the mat. In one embodiment, the center layer does not have polyurethane foam or crumb rubber, or other wicking material other than SAP.

In one embodiment, the salt protection mat further comprises animal repellent.

In one embodiment, the salt protection mat further comprises one or more insect-, bacteria-, and fungi-control agent.

In one embodiment, the salt protection mat further comprises one or more endophytic microbe or mycorrhiza spore.

In one embodiment, the salt protection mat may have sections that are separated by stitching lines, heat sealing lines, adhesive lines, or a combination of two or more thereof.

In one embodiment, the salt protection mat superabsorbent polymer (SAP) particles comprise polyacrylic acid polymer, polyacrylate polymer, starch-grafted polymer, polyacrylamide, ethylene maleic anhydride polymer, carboxymethylcellulose, polyvinyl alcohol, polyethylene oxide, starch grafted copolymer of polyacrylonitrile, Group IA salt of polyacrylic acid, copolymer of two or more thereof, crosslinked copolymer of potassium acrylate and acrylamide, poly(acrylic acid-co-acrylamide), bio-based super absorbent polymer TryEco Agrisorb™, starch-based super absorbent polymer, cellulose-based super absorbent polymer, biodegradable superabsorbent polymer, superabsorbent cellulosic hydrogel, or any combination thereof.

In one embodiment, the SAP particles comprise polyacrylic acid polymer, polyacrylate polymer, starch-grafted polymer, polyacrylamide, ethylene maleic anhydride polymer, carboxymethylcellulose, polyvinyl alcohol, polyethylene oxide, starch grafted copolymer of polyacrylonitrile, Group IA salt of polyacrylic acid, copolymer of two or more thereof, crosslinked copolymer of potassium acrylate and acrylamide, or poly(acrylic acid-co-acrylamide).

In one embodiment, one or more of the salt protection mat sections having superabsorbent particles or not having superabsorbent particles comprise one or more of fertilizer, slow release fertilizer, inorganic fertilizer, organic fertilizer, compost, sludge from waste water treatment plant, sewage sludge, anaerobically digested sludge, biomass by-product from brewery, manure, anaerobically digested animal manure, anaerobically digested biomass, pulp and paper waste, animal repellent, insect repellent, pesticide, fungicide, insecticide, herbicide, microbe, fungus, spore, or a combination of two or more thereof.

In one embodiment, the salt protection mat first and second perimeter edges are affixed to one another directly or to one another via an intervening sidewall via sewing, heat-sealing, friction-welding, laser-welding, ultrasonic-welding, induction-welding, radio-frequency-welding, heat-bonding, adhesive, solvent-welding, stapling, or a combination of two or more thereof.

In one embodiment, the salt protection mat sections of soaker hose, drip emitters or micro-spray emitters are inserted in between of the top and bottom layers and the soaker hose and the emitters can be connected to an irrigation system via connections such as a hose connector.

In one embodiment, the salt protection mat hose connector is attached to the top, bottom layer or the side wall with via sewing, heat-sealing, friction-welding, laser-welding, ultrasonic-welding, induction-welding, radio-frequency-welding, heat-bonding, adhesive, solvent-welding, stapling, or a combination of two or more thereof.

In one embodiment, the method is used in combination with an irrigation or SAP water-charging system, wherein sections of soaker hose, drip emitters or micro-spray emitters can be placed on top of the mat, or in fluid contact with the center layer either directly or via the top layer, bottom layer, or both.

In one embodiment, the irrigation system is an automatic system that are electronically controlled based on the soil moisture level, which is determined using a soil moisture sensor buried underneath the mat.

In one embodiment, the diameter, in the case of a circular-shaped mat, or otherwise the size of the mat is approximately that of the plant's dripline, or larger.

### EXAMPLES

The examples below are provided for a better understanding of embodiments of the invention and its advantages, and are not intended to be limiting unless otherwise specified.

### Example 1

The inventors used a moderately salt tolerant shrub, Shamrock Inkberry Holly (Ilex glabra “Shamrock”). 16 plants were divided into 4 groups: A-D, each group consisting of 4 plants. The plants in Groups A and C were each outfitted with salt protection mats placed on the soil surface around each plant's main trunk, the mats having a diameter larger than that of the plant dripline. As salt protection mats, TreeDiaper® mats, available from Zynnovation, LLC, of Ashland, Va., were used. The TreeDiaper® mats included a top layer; a center layer disposed beneath the top layer and comprising superabsorbent polymer particles; and a semipermeable bottom layer disposed beneath the center layer; wherein the top layer reduces or prevents evaporative water loss from the center layer; and wherein the semipermeable bottom layer permits water to seep out from the center layer. The TreeDiaper® mats were pre-soaked with water, and then covered with mulch. As a control, plants in Groups B and D did not have salt protection mats, but had only mulch around their main trunk. Groups A and B were treated by dripping a salt (NaCl) solution on the rootzone, with best efforts to avoid dripping salt solution on leaves and branches. The plants of Groups C and D were treated with a salt (NaCl) water solution sprayed on their leaves and branches. It should be noted that salt water sprayed on leaves dripped down to root zone. As a result, Groups C and D had salt applied on the leaves, branches, and roots.

Experimental Procedure: In the morning, 1 liter of salt (NaCl) water is applied to the plants according to the method above. In the evening, fresh water, in an amount that equals at least double that of the salt water applied in the morning, is applied to the plants in the same manner the salt water is applied. On rainy days, the experiment was temporarily stopped. The salt water amount, the amount of salt dissolved, and the observations of the plants are recorded. The observations and results are shown below in Table 1.

TABLE 1

| | Total | | | | |
|---|---|---|---|---|---|
| | (Cumulative) | Observations | | | |
| Day | Dry Salt, oz | Group A | Group B | Group C | Group D |

| 1 | 1.4 | 1 Liter Salt Water (3.9% by weight) Applied, in the Morning; | |
|---|---|---|---|
| | | Water in the Evening. No Signs of Damage | |
| 2 | 2.7 | 1 Liter Salt Water (3.9% by weight) Applied, in the Morning; 2 L Fresh | |
| | | Water in the Evening. No Signs of Damage | |
| 3 | 2.7 | Raining Day, No Actions, No Signs of Damage | |
| 4 | 5.5 | 1 Liter Salt Water (7.8% by weight) Applied, in the Morning; 2 L Fresh | |
| | | Water in the Evening. No Signs of Damage | |
| 5 | 9.6 | 1 Liter Salt Water (11.7% by weight) Applied, in the Morning; 2 L | |
| | | Fresh Water in the Evening. No Signs of Damage | |
| 6 | 9.6 | Raining Day, No Actions | |
| | | No Signs of Damage | Signs of wilting leaves observed |
| 7 | 13.7 | 1 Liter Salt Water (11.7% by weight) Applied in the Morning; 2 L | |
| | | Fresh Water in the Evening | |
| | | No Signs of Damage | Signs of wilting leaves observed |
| 8 | 17.9 | 1 Liter Salt Water (11.7% by weight) Applied in the Morning; 2 L | |
| | | Fresh Water in the Evening. | |
| | | No Signs of Damage | Some Leaves Turning Brown |
| 9 | 22.0 | 1 Liter Salt Water (11.7% by weight) Applied in the Morning; 2 L | |
| | | Fresh Water in the Evening. | |
| | | No Signs of Damage | Leaves and young branches turning |
| | | | brown. Stop application salt and |
| | | | observe |
| 10 | 26.9 | 1 Liter Salt Water (11.7% by | No Salt Water Added; 2 L Fresh |
| | | weight) Applied in the | Water Applied |
| | | Morning; 2 L Fresh Water in | |
| | | the Evening. | |

| | | |
|---|---|---|
| No Signs of | Slight Signs | Very Few Were Still Green. Added |
| Damage | of Brown | Fresh Water to See If These Plants |
| | Leaves | Can Recover. |

| | | | |
|---|---|---|---|
| 11 | 31.1 | 1 Liter Salt Water (11.7% by | No Salt Water Added; 2 L Fresh |
| | | weight) Applied in the | Water in the Evening. |
| | | Morning; 2 L Fresh Water in | |
| | | the Evening. | |

| | | |
|---|---|---|
| No Signs of | ~⅓ of | Very Few Were Still Green. Added |
| Damage | Leaves | Fresh Water to See If These Plants |
| | Turning | Can Recover. |
| | Brown or | |
| | with Brown | |
| | Spots | |

| | | | |
|---|---|---|---|
| 12 | 35.2 | 1 Liter Salt Water (11.7% by | No Salt Water Added; 2 L Fresh |
| | | weight) Applied in the | Water in the Evening. |
| | | Morning; 2 L Fresh Water in | |
| | | the Evening. | |

| | | |
|---|---|---|
| No Signs of | Brown Spots | Very Few Were Still Green. Added |
| Damage, | Were Larger | Fresh Water to See If These Plants |
| Some Leaves | on Leaves | Can Recover. |
| Drop | | |

| | | | |
|---|---|---|---|
| 13 | 35.2 | No Salt Water Added; 2 L | No Salt Water Added; 2 L Fresh |
| | | Fresh Water in the Evening. | Water in the Evening. |

| | | |
|---|---|---|
| Slight Signs | Most Leaves | Very Few Were Still Green. Added |
| of Brown | Turned | Fresh Water to See If These Plants |
| Leaves, More | Brown | Can Recover. |
| Leaves Drop | | |

| | | | |
|---|---|---|---|
| 14 | 35.2 | No Salt Water Added; 2 L | No Salt Water Added |
| | | Fresh Water in the Evening. | |

| More Leaves | Plants Died | Plants Died, No More Actions |
|---|---|---|
| Drop, But | | |
| Plants Were | | |
| Still Alive | | |

| | | | |
|---|---|---|---|
| 15 | 35.2 | Same As Day 14 | Same As Day 14 |
| 16 | 35.2 | Same As Day 14 | Same As Day 14 |
| 17 | 35.2 | Same As Day 14 | Same As Day 14 |

At this stage of the experiment Example 1, the plants in Groups B and D without salt protection mat have all died. The plants of Group C were outfitted with the TreeDiaper® salt protection mat, but the salt spray on the leaves killed them at the same amount of salt. Surprisingly, the plants of Group A, which included the TreeDiaper® salt protection mat, lost some leaves, but remained alive after 35.2 oz of salt applied on the rootzone.

### Example 2

For the 4 plants in Group A from Example 1 that were applied 35.2 oz of salt over 17 day period, salt caused some loss of leaves, but the plants remained alive. In this Example, continued application of salt (NaCl) water was carried out on the rootzone. Table 2 shows the experimental record for the 4 plants in Group A (1,3,5,7) with Plant 7 being the control without any further salt application.

TABLE 2

| | Total | | | | |
|---|---|---|---|---|---|
| | (Cumulative) | Observations on Plants of Group A | | | |
| Day | Dry Salt, oz | 1 | 3 | 5 | 7 |
| 18 | 39.3 | 1 Liter Salt Water (11.7% by weight) Applied in the | | | No Salt Water |
| | | Morning; 2 L Fresh Water in the Evening. | | | Added, 2 L |
| | | | | | Fresh Water in |
| | | | | | the Evening. |
| | | More Leaves Drop | | | Alive and No |
| | | | | | More Leaf |
| | | | | | Drops |
| 19 | 43.4 | 1 Liter Salt Water (11.7% by weight) Applied in the | | | 2 L Fresh Water |
| | | Morning; 2 L Fresh Water in the Evening. | | | |
| | | More Leaves Drop, Some | | Very Few Leaves | Alive and No |
| | | Turned Brown | | Left | More Leaf |
| | | | | | Drops |
| 20 | 47.6 | 1 Liter Salt Water (11.7% | | No Salt Water | 2 L Fresh Water |
| | | by weight) Applied in the | | Added; 2 L Fresh | |
| | | Morning; 2 L Fresh Water in | | Water in the | |
| | | the Evening. | | Evening. | |
| | | | | Very Few Leaves | Alive and No |
| | | | | Left, Added Fresh | More Leaf |
| | | | | Water to Save It | Drops |
| 21 | 51.7 | 1 Liter Salt Water (11.7% | | No Actions. | 2 L Fresh Water |
| | | by weight) Applied in the | | | |
| | | Morning; 2 L Fresh Water in | | | |
| | | the Evening. | | | |
| | | Leaves Drop, | More Leaves | Plant Died | Alive and No |
| | | Still Healthy | Drop, Some | | More Leaf |
| | | | Leaves | | Drops |
| | | | Turned | | |
| | | | Brown | | |
| 22 | 55.8 | 1 Liter Salt Water (11.7% | | No Actions. | 2 L Fresh Water |
| | | by weight) Applied in the | | | |
| | | Morning; 2 L Fresh Water in | | | |
| | | the Evening. | | | |
| | | Leaves | Young | Plant Died | Alive and No |
| | | Dropping, But | Branches | | More Leaf |
| | | Still Healthy | Turning | | Drops |
| | | | Brown. Very | | |
| | | | Few Leaves | | |
| | | | Left | | |
| 23 | 59.9 | 1 Liter Salt | Fresh Water | No Actions. | 2 L Fresh Water |
| | | Water (11.7% | Added to | | |
| | | by weight) | Revive the | | |
| | | Applied in the | Plant | | |
| | | Morning; 2 L | | | |
| | | Fresh Water | | | |
| | | in the | | | |
| | | Evening. | | | |
| | | Leaves | Plant Died | Plant Died | Alive and No |
| | | Dropping, But | | | More Leaf |
| | | Still Healthy | | | Drops |
| 24 | 64.0 | 1 Liter Salt | No Actions. | No Actions. | 2 L Fresh Water |
| | | Water (11.7% | | | |
| | | by weight) | | | |
| | | Applied in the | | | |
| | | Morning; 2 L | | | |
| | | Fresh Water | | | |
| | | in the | | | |
| | | Evening. | | | |
| | | More Leaves | Plant Died | Plant Died | Alive and No |
| | | Drop, Some | | | More Leaf |
| | | Branches | | | Drops |
| | | Turned | | | |
| | | Brown | | | |
| 25 | 68.2 | 1 Liter Salt | No Actions. | No Actions. | 2 L Fresh Water |
| | | Water (11.7% | | | |
| | | by weight) | | | |
| | | Applied in the | | | |
| | | Morning; 2 L | | | |
| | | Fresh Water | | | |
| | | in the | | | |
| | | Evening. | | | |
| | | More Leaves | Plant Died | Plant Died | Alive and No |
| | | Drop; Still | | | More Leaf |
| | | Green | | | Drops |
| 26 | 72.3 | 1 Liter Salt | No Actions. | No Actions. | 2 L Fresh Water |
| | | Water (11.7% | | | |
| | | by weight) | | | |
| | | Applied in the | | | |
| | | Morning; 2 L | | | |
| | | Fresh Water | | | |
| | | in the | | | |
| | | Evening. | | | |
| | | More Leaves | Plant Died | Plant Died | Alive and No |
| | | Drop | | | More Leaf |
| | | | | | Drops |
| 27 | 72.3 | No Salt Water | No Actions. | No Actions. | 2 L Fresh Water |
| | | Added | | | |
| | | More Leaves | Plant Died | Plant Died | Alive and No |
| | | Drop | | | More Leaf |
| | | | | | Drops |

After Day 27, Plant 1 was still alive after 72.3 oz (cumulative) of salt applied. Plant 7 was still alive as the control of the Experimental Example 2. Plant 1 died 5 days later with no more salt added. The three plants in Group A (1,3,5) died after 39, 60 and 72 oz of salt applied to them individually. Plant 7 stayed alive after 35 oz of salt applied to its root zone. From this experiment, the salt protection mat offered no observable protection against air-sprayed salt on leaves, all died with 21 oz salt.

The salt protection mat protected the plants with root-applied salt water.

The present invention inheres surprising and unexpected advantages in mitigating salt damage to plants.

Regions requiring large amount of deicing salt often have large amounts of precipitation, which precipitation can recharge the salt protection mat prior to the wintry weather conditions and keeping the water available for release when salts are applied.

Surfaces needing large amounts of deicing salts are typically impervious, where the majority of stormwater runs off. This large amount of stormwater runoff can advantageously recharge the salt protection mat in preparation for the next round of wintry weather conditions.

When potassium-based SAPs are used in the salt protection mat, the potassium ions will replace some of the sodium ions in the soil upon use. Unlike sodium, potassium is a fertilizer for plants, which is beneficial to the plants, rather than damaging to the plants like sodium.

Although irrigation with fresh water is recommended for leaching and washing salt off from the rootzone of plants, irrigation systems are typically shut down during winter time. The longer time salts sit on a field, the deeper it diffuses and the more difficult to leach it out. The salt protection mat is immediately available to help wash off the salt as it enters the plant rootzone.

The entire contents of U.S. Application No. 62/975,049, filed Feb. 11, 2020, U.S. Pat. No. 9,565,809, issued Feb. 14, 2017, and U.S. Published Application No. 20190150377, published May 23, 2019, are hereby incorporated by reference.

What is claimed is:

1. A method for protecting a plant from the effects of contact or exposure to salt and/or salt water, comprising placing, around or near the plant:
a salt protection mat, comprising:
a top layer;
a center layer disposed beneath the top layer and comprising superabsorbent polymer particles; and
a semipermeable bottom layer disposed beneath the center layer;
wherein the top layer reduces or prevents evaporative water loss from the center layer; and wherein the semipermeable bottom layer permits water to seep out from the center layer.

2. The method of claim 1, wherein the salt is de-icing salt, salt brine, rock salt, road salt, airborne salt, salt water, salt solution, seawater, reclaimed water, or a combination thereof.

3. The method of claim 1, wherein the salt water arises from above the ground surface, below the ground surface, saltwater intrusion, flooding, tide, or a combination thereof.

4. The method of claim 1, wherein the mat further comprises a hole through the top, bottom, and center layers through which a tree or plant can grow, the hole being defined by an interior perimeter edge at which the top and bottom layers are affixed directly to one another, or affixed indirectly to one another via an intervening interior perimeter sidewall.

5. The method of claim 4, wherein the mat further comprises an access slit extending from the hole to the first and second perimeter edges, the access slit being defined by access slit perimeter edges at which the top and bottom layers are affixed directly to one another, or affixed indirectly to one another via intervening access slit perimeter edges sidewalls.

6. The method of claim 5, wherein the mat further comprises one or more connections between the access slit perimeter edges, the connections selected from the group consisting of ties, grommets, Velcro, Velcro tabs, zipper, buttons, snaps, hooks, string, cord, or any combination of two or more thereof.

7. The method of claim 1, wherein the mat does not comprise a hole through the top, bottom, and center layers.

8. The method of claim 1, wherein the top layer reduces or prevents evaporative water loss from the center layer.

9. The method of claim 1, wherein top layer is permeable to one or more of water, atmospheric water, dew, rainwater, applied water, snowmelt, icemelt, or a combination of two or more thereof.

10. The method of claim 1, wherein top layer further comprises one or more perforations, funnel, hole, opening, channel, seam, or a combination of two or more thereof, to permit one or more of atmospheric water, dew, rainwater, applied water, snowmelt, icemelt, or a combination of two or more thereof to penetrate into the center layer.

11. The method of claim 1, wherein the top layer is flexible.

12. The method of claim 1, wherein the top layer is flexible and is made of fabric, woven material, non-woven material, film, plastic, laminate, sheeting, polymer, or a combination of two or more thereof.

13. The method of claim 1, wherein the top layer comprises a woven polypropylene material, woven polyethylene material, or a combination thereof.

14. The method of claim 1, wherein the semipermeable bottom layer is flexible and is made of fabric, woven material, non-woven material, film, plastic, laminate, sheeting, polymer, or a combination of two or more thereof.

15. The method of claim 1, wherein the semipermeable bottom layer comprises nonwoven polyethylene fabric, nonwoven polypropylene fabric, or a combination thereof.

16. The method of claim 1, wherein the salt protection mat further comprises a sidewall.

17. The method of claim 1, wherein the superabsorbent polymer particles comprise polyacrylic acid polymer, polyacrylate polymer, starch-grafted polymer, polyacrylamide, ethylene maleic anhydride polymer, carboxymethylcellulose, polyvinyl alcohol, polyethylene oxide, starch grafted copolymer of polyacrylonitrile, Group IA salt of polyacrylic acid, copolymer of two or more thereof, crosslinked copolymer of potassium acrylate and acrylamide, poly(acrylic acid-co-acrylamide), bio-based super absorbent polymer, starch-based super absorbent polymer, cellulose-based super absorbent polymer, biodegradable superabsorbent polymer, superabsorbent cellulosic hydrogel, or any combination thereof.

18. A method for protecting a plant from the effects of contact or exposure to salt and/or salt water, comprising placing a plurality of superabsorbent polymer particles around or near the plant, or admixing a plurality of superabsorbent polymer particles with soil or mulch around or near the plant, or a combination thereof.

19. The method of claim 18, wherein the salt is de-icing salt, salt brine, rock salt, road salt, airborne salt, salt water, salt solution, seawater, reclaimed water, or a combination thereof.

20. The method of claim 18, wherein the salt water arises from above the ground surface, below the ground surface, saltwater intrusion, flooding, tide, or a combination thereof.
